(19) United States
(12) Patent Application Publication
(10) Pub. No.: US 2007/0211954 A1
(43) Pub. Date: Sep. 13, 2007

(54) Image-Processing Control Device, Image-Processing Control Method, And Image-Processing Control Program Storage Medium

(75) Inventor: Hiromi Ohara, Kanagawa (JP)

Correspondence Address: GAUTHIER & CONNORS, LLP, 225 FRANKLIN STREET, SUITE 2300, BOSTON, MA, 02110, US

(73) Assignee: Fuji Xerox Co., Ltd., Tokyo (JP)

(21) Appl. No.: 11/560,907

(22) Filed: Nov. 17, 2006

(30) Foreign Application Priority Data
Mar. 8, 2006 (JP) 2006-063356

(51) Int. Cl. G06K 9/40

(52) U.S. Cl. 382/254

(57) ABSTRACT

There is provided an image-processing control device including: a coordinate acquisition unit that acquires coordinate information with respect to an original electronic document as a printing source of a hard copy from a scanned electronic document created by scanning the hard copy; a policy acquisition unit that acquires security policy information that specifies whether or not processing of the original electronic document on the basis of the coordinate information is allowed; and a process controller that controls electronic processing utilizing the original electronic document to be performed on the hard copy on the basis of the acquired security policy information.

### PRIORITY INFORMATION

This application claims priority to Japanese Patent Application No. 2006-063356, filed on Mar. 8, 2006.

### BACKGROUND

1. Technical Field

The present invention relates to a technology of associating and controlling hard copies and electronic documents and, more specifically, to a processing technology of scanning hard copies.

2. Related Art

In recent years, documents have been computerized in association with development of calculation devices and networks, and development of a paperless office is in progress. Under such circumstances, transmission of document information, for example, is performed by preparing and distributing an electronic document by means of a PC (personal computer) or the like.

At present, however, in many cases the electronic document and a document printed on a recording paper coexist.

Therefore, there is employed a technology of creating a document printed on the recording paper from the electronic document and specifying the original electronic document from the document printed on the recording paper.

### SUMMARY

According to an aspect of the invention, there is provided an image-processing control device including: a coordinate acquisition unit that acquires coordinate information with respect to an original electronic document as a printing source of a hard copy from a scanned electronic document created by scanning the hard copy; a policy acquisition unit that acquires security policy information that specifies whether or not processing of the original electronic document on the basis of the coordinate information is allowed; and a process controller that controls electronic processing utilizing the original electronic document to be performed on the hard copy on the basis of the acquired security policy information.

### BRIEF DESCRIPTION OF THE DRAWINGS

Exemplary embodiments of the present invention will be described by reference to the following figures, wherein:

FIG. 1 is a schematic drawing showing an example configuration of an image-processing system;

FIG. 2 is a schematic drawing showing an example configuration of an image-forming device;

FIG. 3 is a schematic drawing showing a modification of the configuration of the image-processing system;

FIG. 4 is a schematic drawing showing another modification of the configuration of the image-processing system;

FIG. 5 is a sequence chart that explains processing according to an exemplary embodiment 1;

FIG. 6 is a flowchart that explains the processing according to the exemplary embodiment 1;

FIG. 7 is a sequence chart that explains processing according to an exemplary embodiment 2;

FIG. 8 is a flowchart that explains the processing according to the exemplary embodiment 2;

FIG. 9 is a sequence chart that explains processing according to an exemplary embodiment 3;

FIG. 10 is a flowchart that explains the processing according to the exemplary embodiment 3;

FIG. 11 is a flowchart that explains processing according to an exemplary embodiment 4;

FIG. 12 is a flowchart that explains processing according to an exemplary embodiment 5; and

FIG. 13 is a sequence chart that explains processing according to an exemplary embodiment 6.

### DETAILED DESCRIPTION

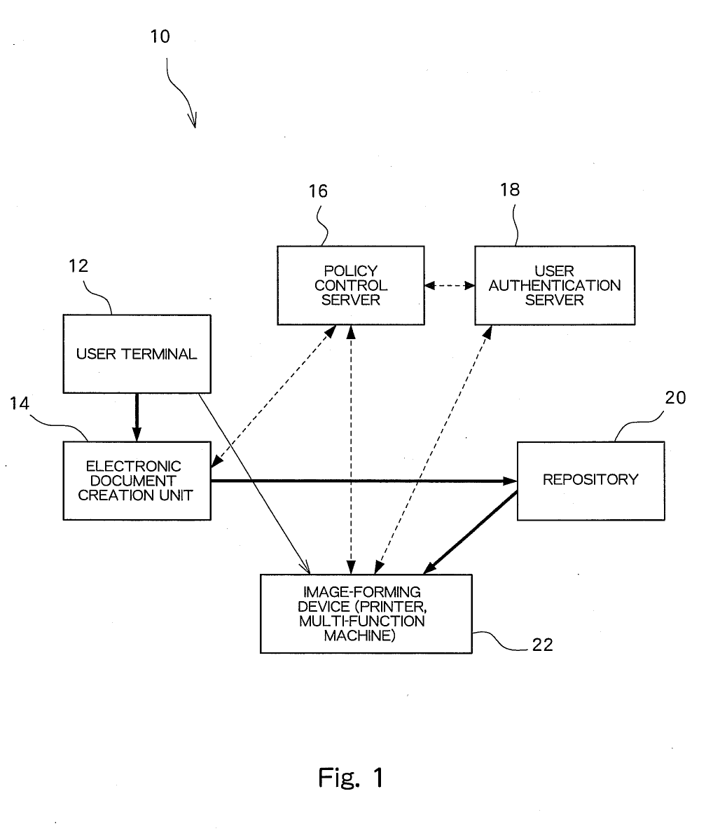

Referring now to FIG. 1 to FIG. 4, an example configuration of an image-processing system according to an exemplary embodiment will be described.

FIG. 1 is a schematic drawing that explains a configuration of an image-processing system 10. The image-processing system 10 includes a user terminal 12, an electronic document creation unit 14, a policy control server 16, a user authentication server 18, a repository 20, and an image-forming device 22.

The user terminal 12 is a device used by a user as an operator to give an instruction of operation in the image-processing system 10. The user terminal 12 provides to the electronic document creation unit 14 an instruction to create a new electronic document, or provides to the image-forming device 22 an image-processing instruction for an electronic document.

The electronic document creation unit 14 is a device that creates a new electronic document on the basis of an instruction supplied from the user terminal 12 and provides a security policy to the electronic document. Creation of a new electronic document can be performed by creating a new electronic document, copying of an existing electronic document, or converting contents data into an electronic document or the like. Provision of the security policy to the created electronic document is performed by providing the electronic document and the security policy respectively with identification information that correlates that document and the security policy. The identification information provided to the electronic document may be provided as non-document data such as a file name or embedded meta information, or as document data visibly or invisibly inscribed in the document. The identification information provided to the electronic document may be subjected to processing which makes alteration or falsification difficult, such as encryption processing or the like. There may be a case in which the identification information in the form of non-document data are converted into the document data so that the identification information is inscribed in a hard copy when the electronic document is printed to output the hard copy.

The policy control server 16 is a device that individually controls security policies for electronic documents. The security policies are sent to and stored in the policy control server 16 set by the electronic document creation unit 14, and are referred to as needed when operating the electronic document. The security policy is information that controls the document which can be set for each electronic document. The security policy can include, for example, direct operation authentication information such as copying, printing, delivery, reading, and writing. It may also include indirect operation authentication information indicating whether or not scanning after printing is allowed, or whether or not creation of an electronic document using the original electronic document when scanning is allowed. The security policy is typically set for each user, or for each user group.

The user authentication server 18 is a server that performs authentication of the user. The user authentication server 18 serves not only to authenticate a user who attempts to perform processing for the electronic document but also to transmit user information to the policy control server 16. The user authentication is performed, for example, on the basis of a public-key crypto system.

The repository 20 is a device that stores the electronic document created by the electronic document creation unit 14. The repository 20 can be established by a specific file server, a local storage of the image-forming device 22, a local storage of the user terminal 12 or the like, as well as by using a file server on the Internet, a common file storage unit of P2P (Peer to Peer), or the like.

The image-forming device 22 is a device provided with a function for printing the electronic document on a printing sheet, and is composed, for example, of a printer or a multi-function machine provided with a printer function as well as multiple image-processing functions. The image-forming device 22 performs printing of the electronic document stored in the repository 20 on the basis of an instruction from the user terminal 12. During printing, the user authentication is performed by means of the user authentication server 18, and an inquiry is made to the policy control server 16 about whether or not the user is authorized for printing output.

The image-processing system 10 may be composed of a single device or of multiple devices. For example, the user terminal 12 and the electronic document creation unit 14 may be a PC (Personal computer) provided with word processing software and graphic software, may be a scanner, or may be a multi-function machine having a scanning function as well as multiple image-processing functions. When the user terminal 12 and the electronic document creation unit 14 a recombined in a PC, the user gives an instruction to create an electronic document via a user interface of the PC, and then, creation of the electronic document and setting of the security policy are performed by an arithmetic processing function of the PC. When the user terminal 12 and the electronic document creation unit 14 are combined in the multi-function machine provided at least with a printer function, the multi-function machine can also serve as the image-forming device 22.

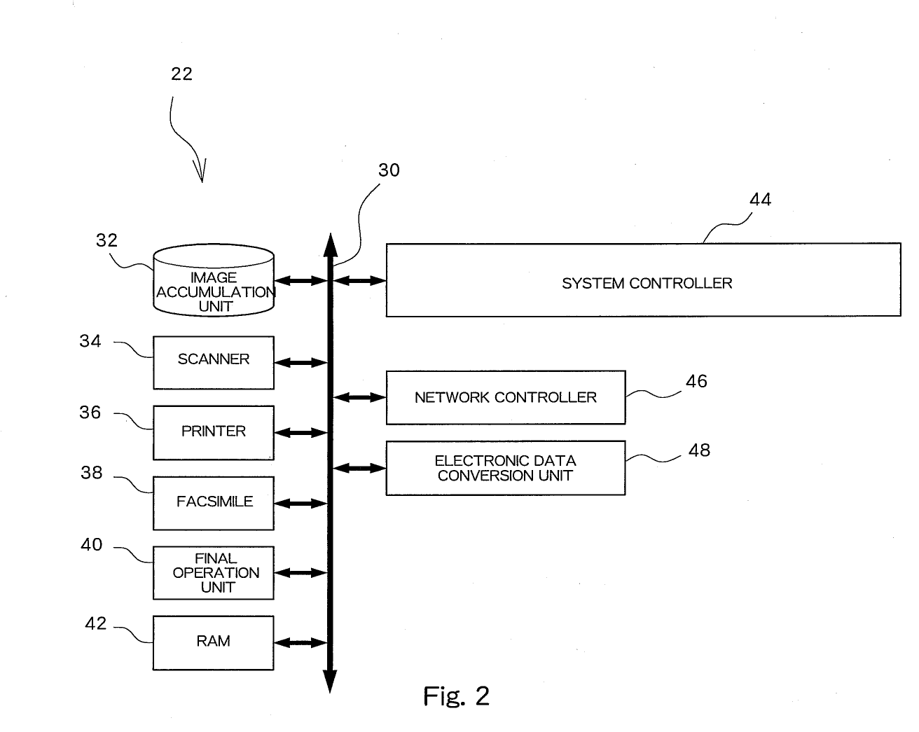

FIG. 2 is an explanatory drawing showing a configuration in the case where the image-forming device 22 is a multi-function machine. A network 30 as a data transfer path is provided in the image-forming device 22, and an image accumulation unit 32, a scanner 34, a printer 36, a facsimile 38, a final operation unit 40, a RAM (Random Access Memory) 42, a system controller 44, a network controller 46, an electronic data conversion unit 48 are connected to the network 30.

The image accumulation unit 32 is a storage area formed by a hard disk or the like. It can also serve as the repository 20 shown in FIG. 1. The scanner 34 is a device that reads a document printed on a sheet of paper and creates a scanned electronic document obtained by converting the read result into an image. The printer 36 is a device that prints an image on the printing sheet on the basis of the electronic document, and the facsimile 38 is a device that transmits the electronic document to an external facsimile. The final operation unit 40 is a user interface on which buttons or the like that are operated by the user are arranged, and can serve also as the user terminal 12. The RAM 42 is a storage area used for temporarily storing the electronic document or the like.

The system controller 44 is a device that controls the operation timing or the like of each device in accordance with settings defined by a program, and the network controller 46 controls data communication performed between the respective devices and the external devices via the network. The electronic data conversion unit 48 is a device that performs conversion of the electronic document and, for example, performs processing such as copying of the electronic document as well as deletion of font data, images, or programs contained in the electronic document, conversion of the colored image data into the non-colored image data, or lowering of resolution. The electronic data conversion unit 48 can also set the security policy to the electronic document.

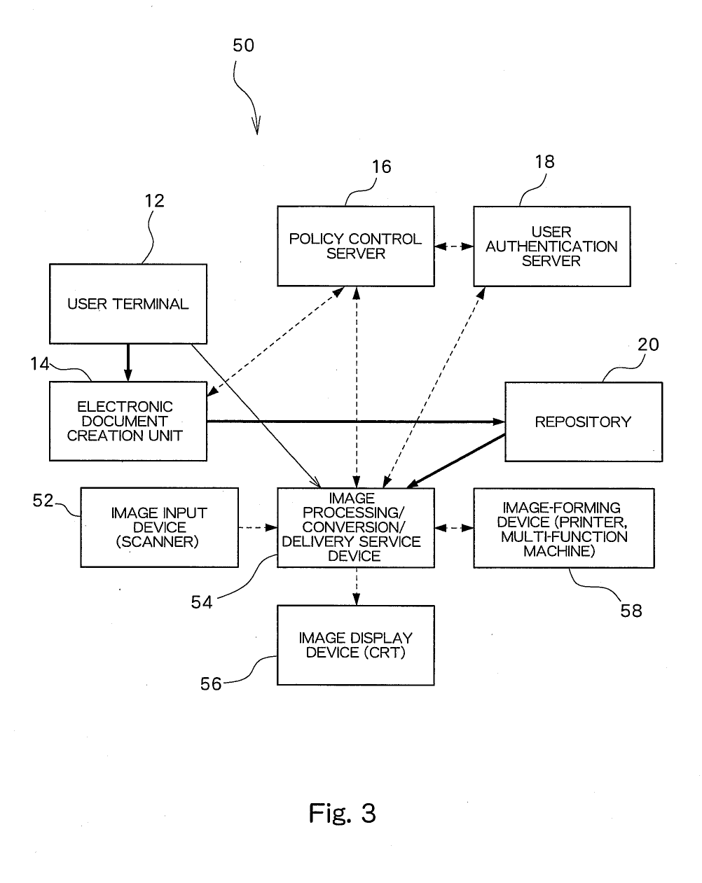

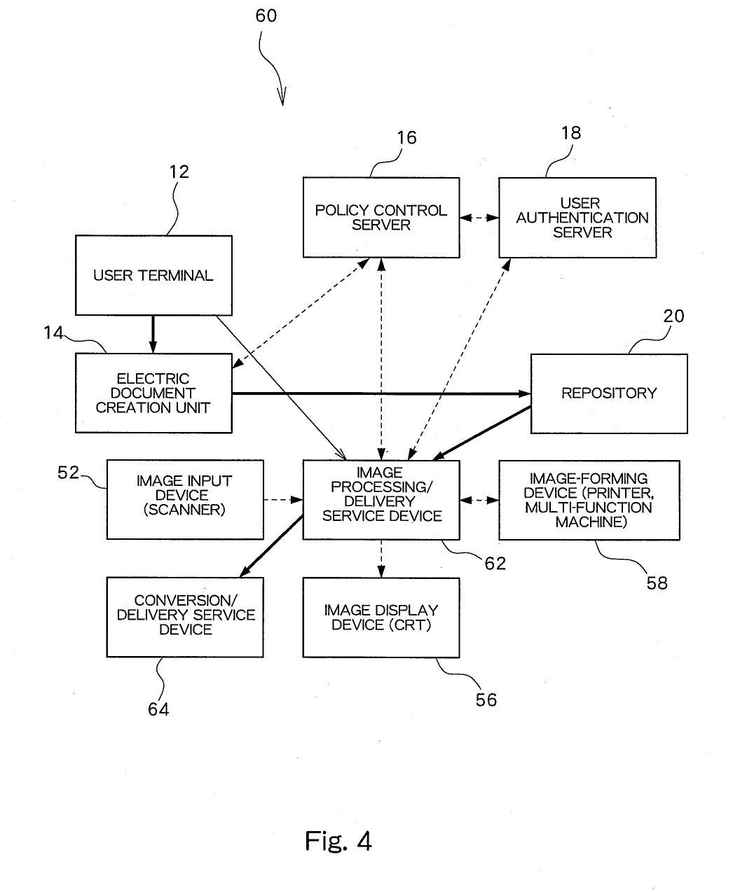

Referring now to FIG. 3 and FIG. 4, a modification of the image-processing system 10 shown in FIG. 1 will be described. In FIG. 3 and FIG. 4, configurations which are the same or correspond to those in FIG. 1 are represented by the same reference numerals, and description will be simplified.

An image-processing system 50 shown in FIG. 3 includes the user terminal 12, the electronic document creation unit 14, the policy control server 16, the user authentication server 18, and the repository 20 as the image-processing system 10 shown in FIG. 1. However, in this case, the image-forming device 22 in FIG. 1 is not provided, and a processing system including an image input device 52, an image processing/conversion/delivery service device 54, an image display device 56, and an image-forming device 58 is provided instead.

The image input device 52 is a device that creates or inputs the electronic document and, for example, when the scanner is used, the scanned electronic document can be obtained from a hard copy. The image-processing/conversion/delivery service device 54 is a device that performs processing, conversion, or delivery of the electronic document and, for example, can be configured by a PC in which a predetermined program is installed. The image processing/conversion/delivery service device 54 performs the user authentication using the user authentication server 18 and acquisition of the security policy from the policy control server 16, and performs processing of the electronic document in accordance with the user's security policy. The electronic document to be processed may be an electronic document supplied from the image input device 52, and may be an electronic document stored in the repository 20. The image processing/conversion/delivery service device 54 can display the electronic document before and after processing on the image display device 56 composed of a CRT, a liquid crystal display, or the like, and can print the electronic document before and after processing in the image-forming device 58 composed of a printer or a multi-function machine.

An image-processing system 60 shown in FIG. 4 includes the image processing/delivery service device 62 and a conversion/delivery service device 64 instead of the image processing/conversion/delivery service device 54 in the image processing system 50 shown in FIG. 3. Here, the conversion/delivery service device 64 is assumed to be a device that performs an advance conversion service provided by an application service provider, and is used by being connected from the image processing/delivery service device 62 to the network. For example, when delivery of the electronic document to the outside after conversion is desired, the conversion/delivery service device 64 may acquire the electronic document which is converted by the conversion/delivery service device 64 and deliver the acquired electronic document by itself, or may make the conversion/delivery service device 64 perform conversion and delivery.

As described thus far, the image-processing system can be configured in various manner using one or multiple devices. When the multiple devices are used, in addition to a mode of connecting the respective devices directly, a mode of connecting the respective devices via the network can also be employed.

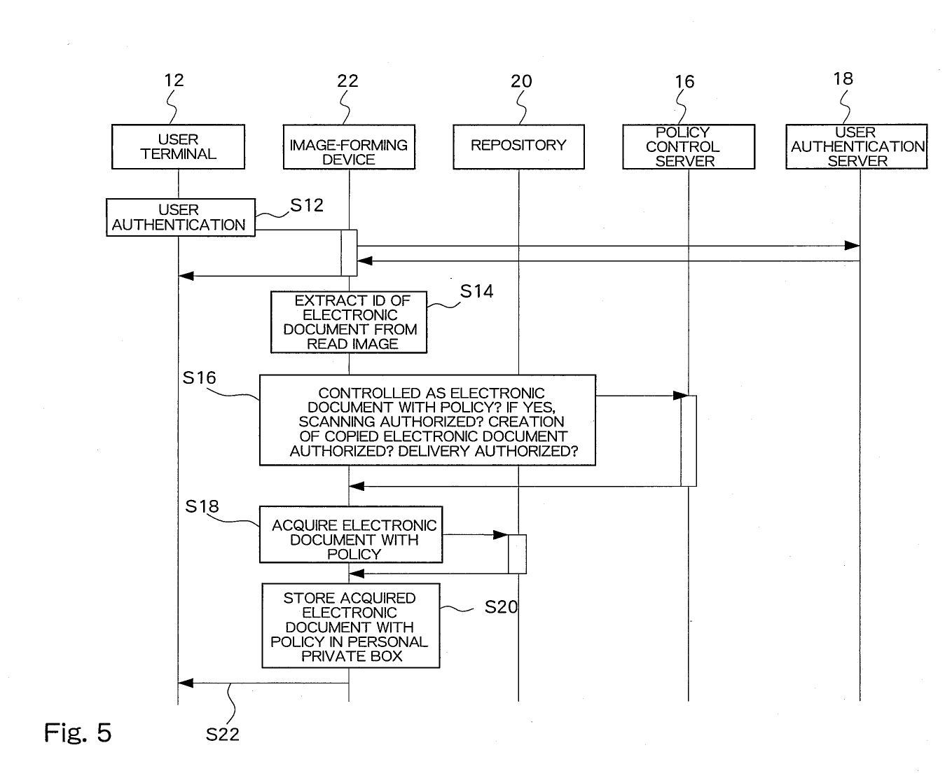

Referring now to FIG. 5 to FIG. 13, various examples of image-processing using the image-processing system are described as exemplary embodiments 1 to 6 below. In the respective exemplary embodiments described here, it is assumed that a new electronic document is created in advance in the electronic document creation unit 14, is stored in the repository 20, and is printed on a printing paper in the image-forming device 22, and the security policy of the electronic document is stored in the policy control server 16. In the respective exemplary embodiments, various modes in the case of scanning the hard copy printed on the printing paper by the image-forming device 22 will be described.

### Exemplary Embodiment 1

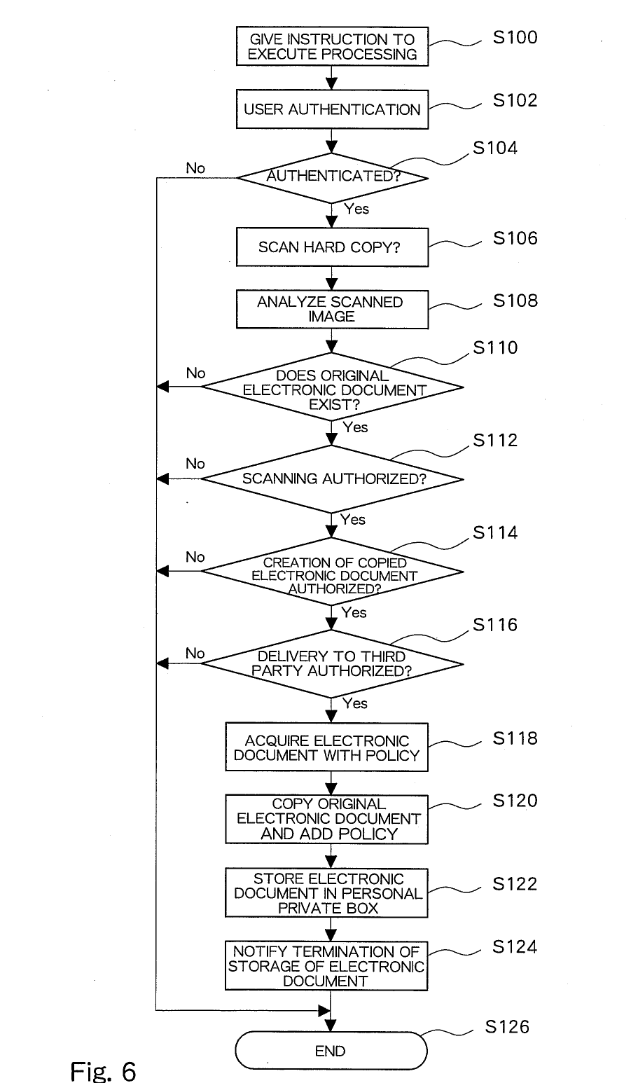

Referring now to FIG. 5 and FIG. 6, there will be described a mode of creating an electronic document corresponding to a hard copy using the original electronic document and storing the same in a personal private BOX in a case where the hard copy is scanned.

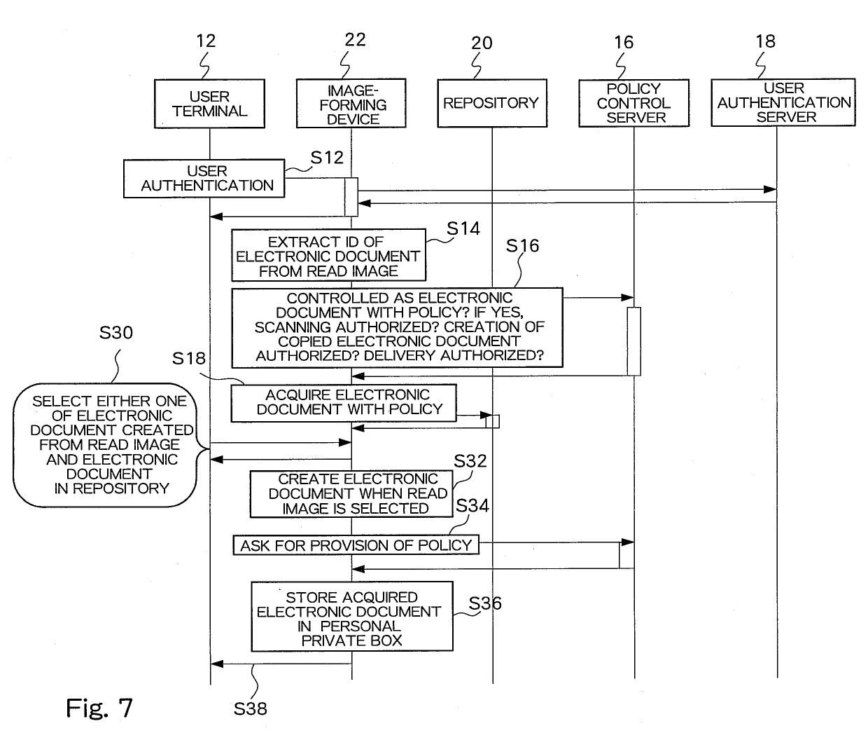

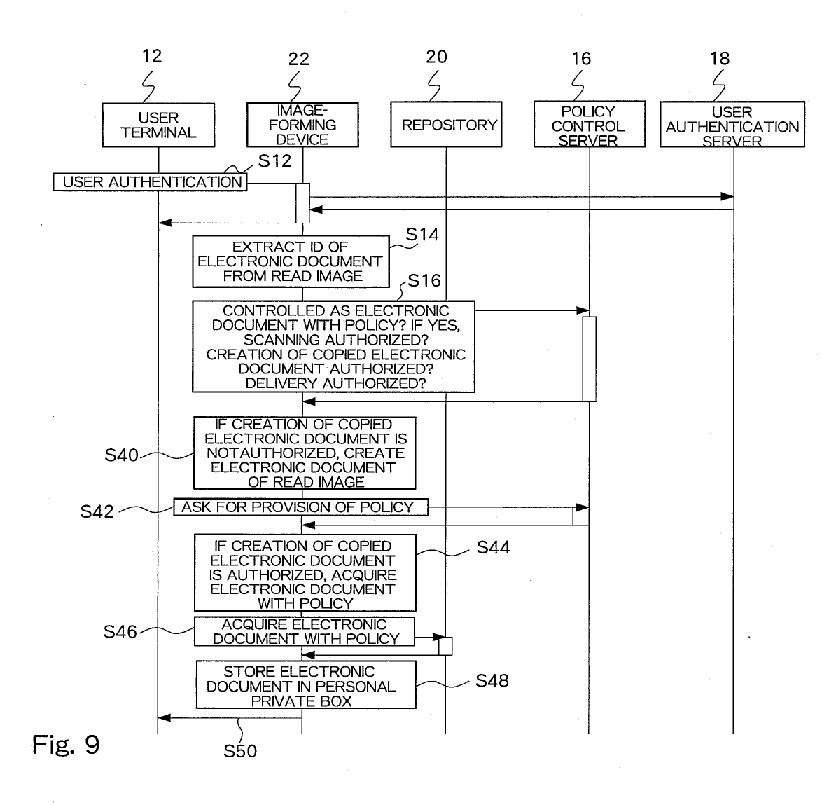

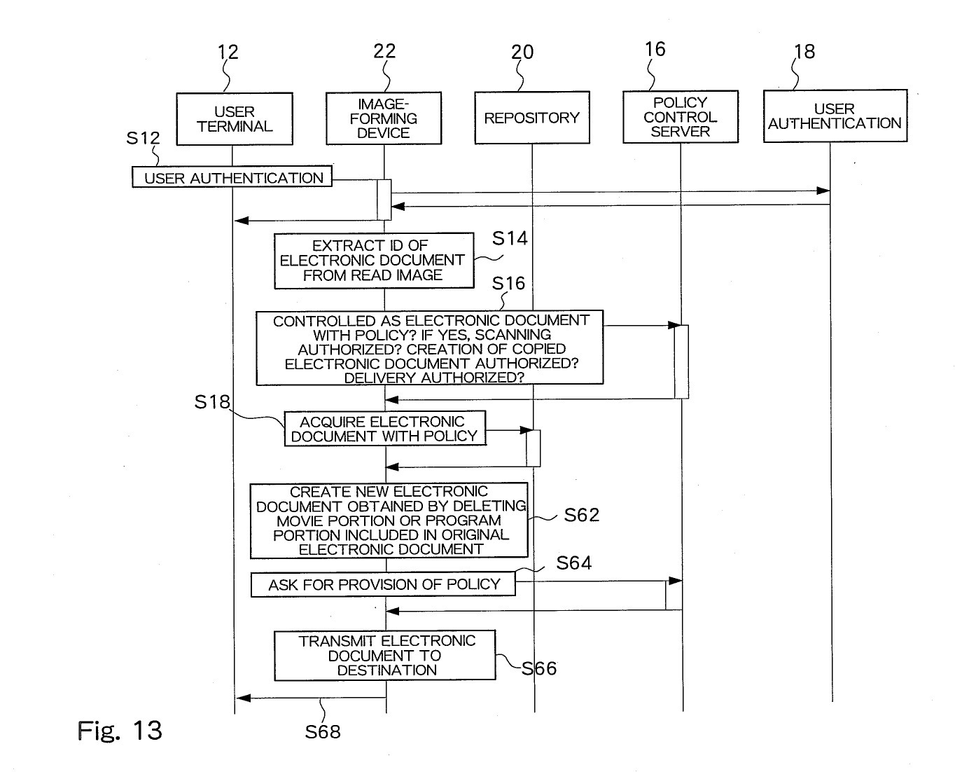

FIG. 5 is a sequence chart showing a relation between processing performed in the respective components and processing among the components. In FIG. 5 and subsequent sequence charts (FIG. 7, FIG. 9, FIG. 13), usage of the image-processing system 10 shown in FIG. 1 is kept in mind, and the user terminal 12, the image-forming device 22 serving as the multi-function machine, the repository 20, the policy control server 16, and the user authentication server 18 are shown as the components.

When the user gives an instruction to create the electronic document from the hard copy via the user terminal 12, the instruction is transmitted to the image-forming device 22 from the user terminal 12, and user authentication of the user is performed (S12). In the user authentication, user information transmitted from the user terminal 12 to the image-forming device 22 is further transmitted to the user authentication server 18, the user authentication server 18 performs the authentication, and the result is returned to the user terminal 12 via the image-forming device 22.

Subsequently, the image-forming device 22 reads the hard copy, and extracts an ID (identification information) for identify the original electronic document from an electronic image (expressed in a raster format in many cases) as a created scanned electronic document (S14). Then, an inquiry is made to the policy control server 16 about whether or not the original electronic document corresponding to the ID is controlled, and if so, an inquiry is made as to whether or not the user in question has aright to scan, aright to create the original electronic document, and a right to deliver the original electronic document (S16) When the inquiry proves that the original electronic document is controlled and the user has the respective rights, the image-forming device 22 copies the original electronic document stored in the repository 20 and obtains anew electronic document, and then sets to the new electronic document a security policy having the same contents as the security policy of the original electronic document (S18). When the security policy is set, the security policy is registered to the policy control server as needed. At last, the image-forming device 22 stores the obtained new electronic document in the personal private BOX which is the user's personal area (S20).

The flow of this processing will be described again by reference to a flowchart shown in FIG. 6. When an instruction to perform processing is issued from the user (S100), the authentication of the user is performed in the user authentication server 18 (S102). Then, whether or not the authentication was successful is confirmed (S104). When the authentication has failed, the processing is ended, and when the authentication has succeeded, the image-forming device 22 scans the hard copy (S106) In the image-forming device 22, the image obtained by scanning (the scanned electronic document) is analyzed, and if identification information is embedded, the identification information is obtained (S108). Then, an inquiry is made to the policy control server 16 about whether or not the original electronic document exists (S110), whether or not the user has a right to scan the original electronic document (S112), whether or not the user has aright to copy the original electronic document (S114), and whether or not the user has a right to deliver the original electronic document to a third party (S116).

When a result of the inquiry shows that one or more of the conditions are unsatisfied, the processing is ended and the scanned electronic document is deleted as needed. On the other hand, if all the conditions are satisfied, data of the original electronic document are acquired (S118), and a new electronic document which is a copy of the original electronic document is created and the security policy of the original electronic document is provided thereto (S120). In other words, the identification information is embedded to the new electronic document as corresponding information, and the set security policy is coordinated to the identification information and registered to the policy control server. Then, the electronic document is stored in the personal private BOX of the user as the destination, storage of the electronic document is notified to the user (S124) and the processing is ended (S126). It is also possible to store the electronic document in the repository 20 and other storage devices instead of storing the same in the personal private BOX.

### Exemplary Embodiment 2

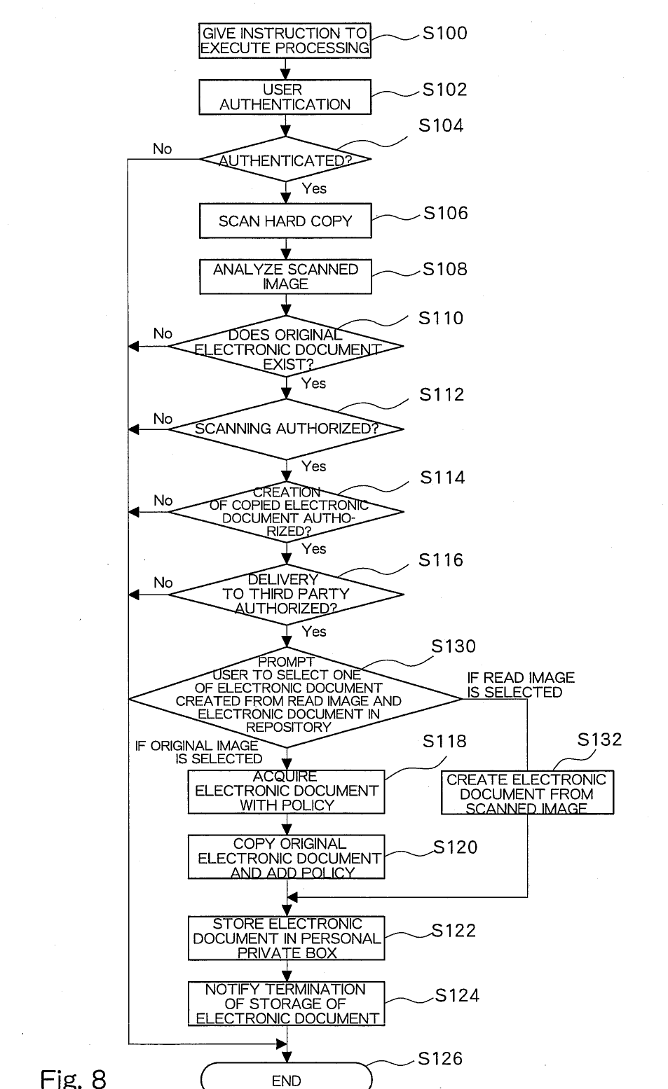

Referring now to FIG. 7 and FIG. 8, a modified mode of the exemplary embodiment 1 will be described. FIG. 7 and FIG. 8 correspond to FIG. 5 and FIG. 6 respectively, the same configurations and processing are represented by the same reference numerals, and repeated description is simplified.

In processing shown in the sequence chart in FIG. 7, the steps until the acquisition of the original electronic document in the repository 20 (S18) are performed as the processing shown in the sequence chart in FIG. 5. However, in the subsequent steps, firstly, an inquiry is made to the user about whether the electronic document corresponding to the hard copy is created from the read image (scanned electronic document) or from the original electronic document. Then, processing is performed on the basis of the selected result supplied from the user terminal 12 (S30). For example, when the reading image is selected, the identification information is embedded to the image as needed, and the electronic document corresponding to the hard copy is created (S32). Then, the security policy corresponding to the original electronic document is registered to the policy control server 16 as a security policy of the created electronic document (S34). The electronic document created in this manner is stored in the user's personal private BOX as a destination (S36), and that event is reported to the user terminal 12 (S38).

This mode will now be described by reference to the flowchart in FIG. 8. The point of difference between FIG. 8 and FIG. 6 lies in that after step S116 selection of the basic electronic document behind the electronic document corresponding to the hard copy to be created is committed to the user. In other words, the user is committed to select, as the basic electronic document behind the electronic document corresponding to the hard copy to be created, one of the scanned electronic document created from the read image and the original electronic document stored in the repository (S130). When the original electronic document is selected, the same processing as that from step S118 shown in FIG. 6 is performed. On the other hand, when the read image is selected, the electronic document is created on the basis of the scanned electronic document (S132).

### Exemplary Embodiment 3

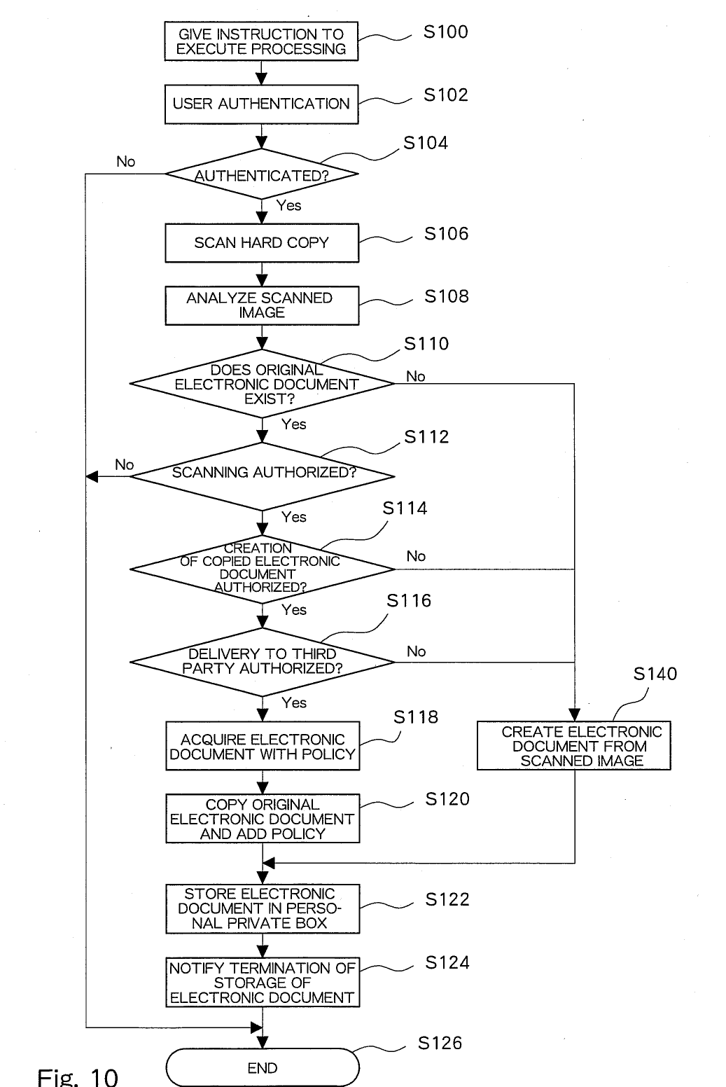

Referring now to FIG. 9 and FIG. 10, another example of modification of the exemplary embodiment 1 will be described. The main difference between FIG. 9 and FIG. 5 lies in that when the electronic document relating to the hard copy cannot be created by copying the original electronic document as a result of the inquiry to the policy control server 16 (S16), it is created automatically on the basis of the read image (S40) The same security policy as the security policy of the original electronic document is set for this new electronic document, and is registered in the policy control server 16 (S42). When a new electronic document can be created by copying the original electronic document, the same processing as in the case shown in FIG. 5 is performed. In other words, the original electronic document is acquired from the repository 20, and the same security policy is employed (S46). The created new electronic document is stored in the user's personal private BOX as a destination, and this event is reported to the user terminal 12 (S50).

FIG. 10 is a flowchart showing the flow of this processing. The difference between FIG. 10 and FIG. 6 lies in that when the results of determination in the respective steps of S110, S114, S116 show that no original electronic document exists, or when the user does not have a predetermined authority over usage of the original electronic document, the electronic document is created from a scanned image (S140).

### Exemplary Embodiment 4

In exemplary embodiments 4 to 6, a mode of transmitting the created electronic document by an electronic mail will be described. In the case of transmission by the electronic mail as well, the basic mode may be the same as those in the exemplary embodiments 1 to 3, and what is to be performed is merely transmitting the electronic document by the electronic mail instead of storage in the personal private BOX.

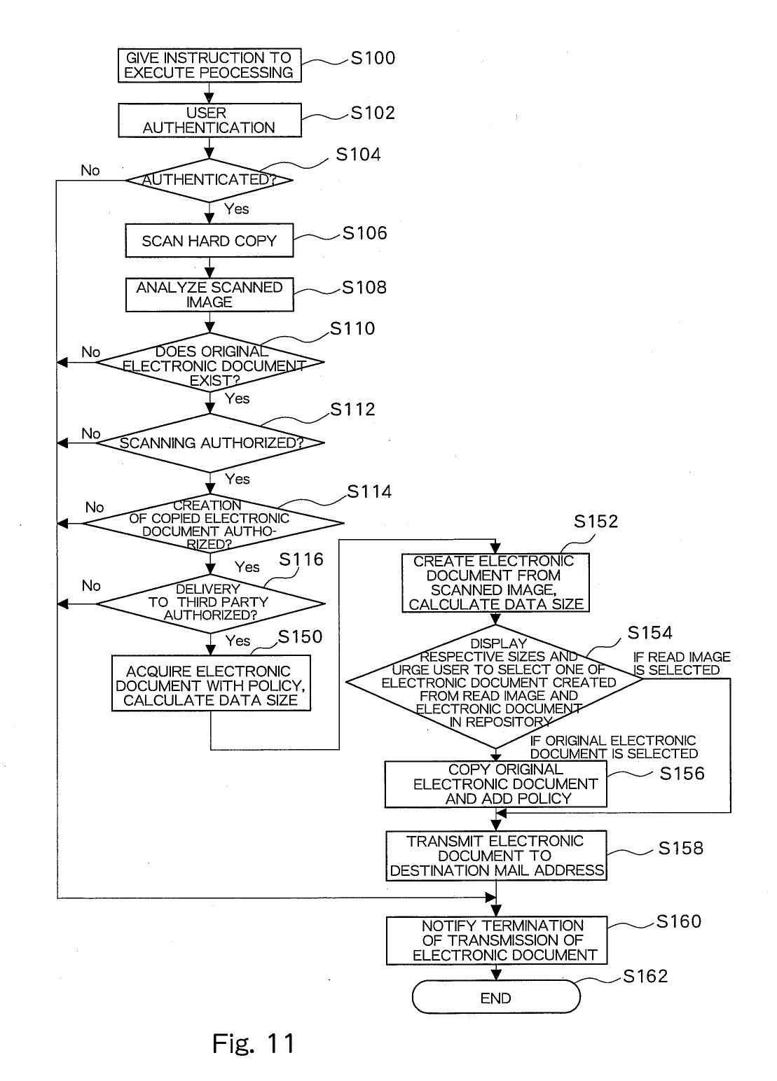

FIG. 11 is a flowchart showing a flow of processing in the exemplary embodiment 4. Here, being different from the case of the exemplary embodiment 1 (FIG. 6), the original electronic document is acquired and the data size thereof is calculated after Step S116 (S150). The electronic document is also created from the scanned image, and the data size thereof is calculated (S152). Then, the calculated data sizes of both electronic documents are presented to the user, and the user is allowed to select one of the electronic documents to be employed (S154). When the user is allowed to select, it is also possible to present a recommended electronic document to the user in accordance with the preset criteria. When the original electronic document is selected as a result of the selection by the user, the original electronic document is copied, the security policy is set, and a new electronic document is created (S156). On the other hand, when the read image data are selected, the security policy is provided to the data and the electronic document is created. The electronic document created in this manner is transmitted to the address specified by the electronic mail (S158), and the transmission is reported to the user (S160) to thereby end the processing (S162).

It is also possible to show a data size obtained after compression by data size compression software instead of the data sizes of the original electronic document and the read image data.

### Exemplary Embodiment 5

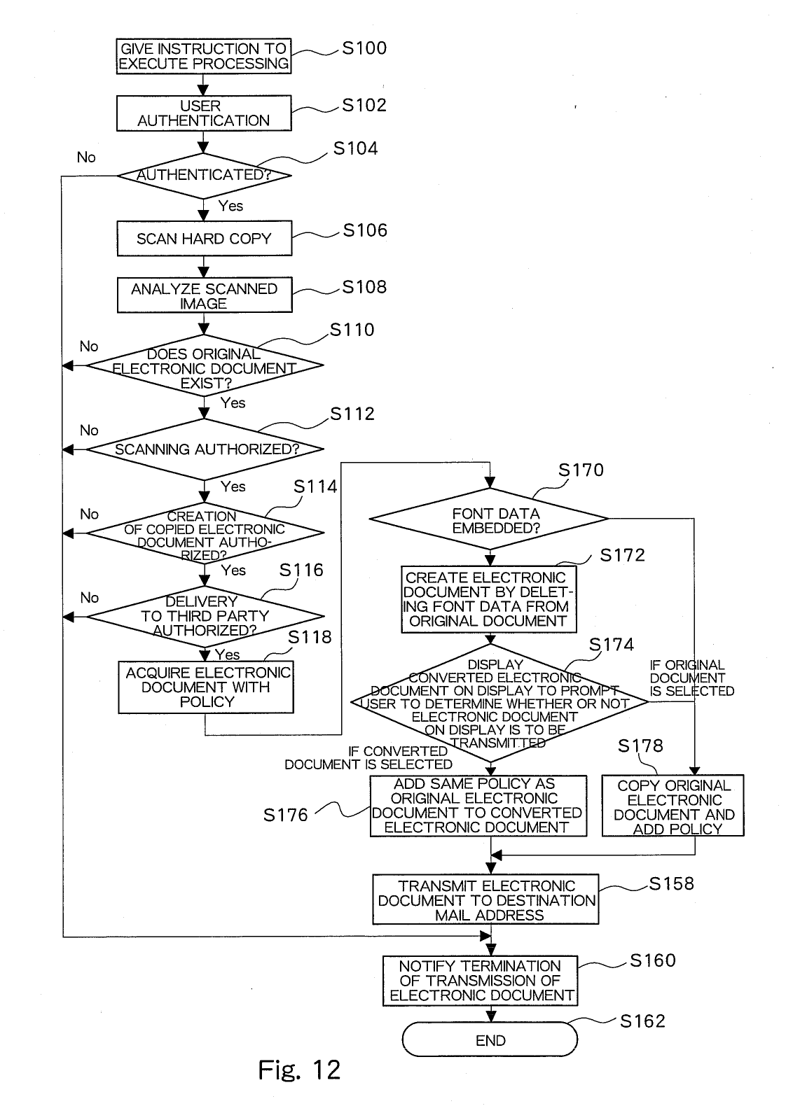

FIG. 12 is a flowchart showing a flow of processing in this exemplary embodiment. In the processing here, focus is put on font data embedded in the electronic document. For example, in an electronic document expressed in a vector format, there may be a case where information such as a font size or a font and font data is embedded. Therefore, when there is no influence on readability or when the font data are not necessary, such font data are deleted.

More specifically, whether or not the font data are embedded in the electronic document is inspected after the electronic document has been acquired in step S118 (S170). Then, when the font data are embedded, the electronic document which is converted to an electronic document from which the font data have been removed is created (S172). Subsequently, the converted electronic document is displayed on the display, and the user selects employment of the converted electronic document or employment of the original electronic document (S174). Consequently, when the converted electronic document is selected, the security policy is provided to the selected electronic document (S176). On the other hand, when it is determined that the font data are not embedded in step S170, or when the original electronic document is selected in step S174, the original electronic document is copied and then the security policy is set to create a new electronic document (S178). The process of transmitting the electronic document created in this manner by electronic mail is performed in the same manner as in the exemplary embodiment 4.

Although here the converted electronic document is displayed on the display, it is also possible to omit the display process. When the destination of transmission is a multi-function machine or a facsimile, and hence the electronic document is to be printed out, it is also possible to print out the converted electronic document instead of or in combination with displaying the same on the display.

### Exemplary Embodiment 6

FIG. 13 is a sequence chart showing a flow of processing in an exemplary embodiment 6. Here, the processing until step S18 is the same as in the case of the exemplary embodiment 1 shown in FIG. 5. Subsequently, however, in the image-forming device 22, a determination is made as to whether or not a movie or a program is contained in the obtained original electronic document. When the movie or the program is integrated in the electronic document, the data size is remarkably increased in general. Therefore, the process of deleting the movie or the program from the electronic document is performed to thereby create a new electronic document (S62). Then, a security policy is provided to the electronic document by registering the same to the policy control server 16, and then transmission of the electronic document and reporting to the user terminal 12 are performed. In this processing process, it is also possible to make an inquiry to the user about whether or not the converted electronic document is to be employed, by displaying the converted electronic document on the display or by printing it out.

Reduction of the data size can be achieved in other modes. For example, there may be a case where colored image data contained in the electronic document can be converted into non-colored image data (gray scaled, or binarized). In particular, when the color display is not made at the destination, reduction of the data size is achieved by conversion into the non-colored image data. Alternatively, it is also possible to reduce the data size by lowering the resolution of the electronic document. For example, when the destination is a mobile terminal, and hence has only a small size display, the resolution can be reduced.

Subsequently, various modifications of this exemplary embodiment will be described. The description below may partially overlap the description given above.

The image-processing control device can be configured with hardware provided with a computing function and software that specifies the operation thereof. The image-processing control device may be provided with some or all of a scanner, a storage device for the original electronic document, a storage device for the security policy, and an electronic processing executing device, or may configure a system having these devices as external devices and using these devices by data transmission or controlling these devices.

The hard copy is a document printed on paper (including alternatives formed of resin or the like), and the electronic document is a document established as electronic data. No specific limitation is imposed on the format of the electronic data, and it may be a vector format or a raster format. Here, “document” is a general expression which indicates general documents, and encompasses those including characters, those without characters, and those including drawings or photographs. The electronic document may have additional data such as a program or a movie embedded therein, or may have a link to external information embedded therein.

The coordinate acquisition unit is a unit that acquires coordinate information from the scanned electronic document. The scanned electronic document is an electronic document obtained by converting a portion or all of the hard copy into an electronic data by scanning. The hard copy here is assumed to be one printed from the original electronic document as a printing source. In other words, the hard copy is created by printing on the basis of the original electronic document or by further copying the printed material. The hard copy may be printed with the coordinate information; that is, identification information or the like for coordinating with the original electronic document. The coordinate information may be directly coordinated with the original electronic document, or may be coordinated with the original electronic document indirectly via intermediate information provided separately. The coordinate acquisition unit is the unit that acquires the coordinate information.

The policy acquisition unit is a unit that acquires security policy information on the basis of the coordinate information. The security policy information to be acquired is information that indicates whether or not one or multiple steps of processing relating the original electronic document is allowed. When a certain basic processing is prohibited, specific processing included in the process of execution of the basic processing may be prohibited. The security policy information may be specified for each user, or for each group to which the user belongs, or may be specified generally irrespective of the specific user.

The process controller controls electronic processing on the basis of the security policy. The controlled electronic processing is processing using the original electronic document performed relating to the hard copy; that is, performing the processing relating “document” information printed on the hard copy by using the “document” information of the original electronic document. Control may be, for example, positive control which allows or prohibits specific processing, or may be negative control which does not allow or does not prohibit the specific processing.

In one mode of the image-processing control device, the electronic processing is processing for creating a new electronic document corresponding to the hard copy using the original electronic document, and the security policy information includes information which specifies whether or not creation of the new electronic document using the original electronic document is allowed. Examples of the information which specifies whether or not creation of the new electronic document on the basis of the original electronic document is allowed include information that specifies whether or not copying of the original electronic document is allowed and, if it is to be converted, information that specifies whether or not conversion of the original electronic document is allowed, and information that specifies whether or not reading itself of the original electronic document is allowed. Examples of control include a mode such that when specification in the security policy information is affirmative, creation on the basis of the original electronic document is admitted or creation is performed on the basis of the original electronic document, and a mode such that when the specification in the security policy information is negative, creation on the basis of the original electronic document is prohibited or creation is performed on the basis of the scanned electronic document.

In one mode of the image-processing control device, the electronic processing is processing for delivering the electronic document corresponding to the hard copy using the original electronic document. The security policy information includes information which specifies whether or not delivery of the electronic document using the original electronic document is allowed. Examples of information which specifies whether or not creation of a new electronic document on the basis of the original electronic document is allowed include information that specifies delivery thereof and, if it is to be converted, information that specifies whether or not conversion is allowed, and information that specifies whether or not reading of the electronic document itself is allowed. Examples of control include a mode such that when specification in the security policy information is affirmative, delivery on the basis of the original electronic document is admitted or delivery is performed on the basis of the original electronic document, and a mode such that when the specification in the security policy information is negative, delivery on the basis of the original electronic document is prohibited or delivery is performed on the basis of the scanned electronic document. The term “delivery” here means performing data transmission to a third party or to an external device. Examples of delivery include a mode of transmission to the external device by an electronic mail or a facsimile as well as a mode of transmitting data within the same device or to an area controlled by the user in the related device.

In one mode of the image-processing control device, the electronic processing is processing for creating or delivering an electronic document corresponding to the hard copy using the converted electronic document obtained by deleting font data in the case where the original electronic document includes font information and the font data. The electronic document may include the font information relating the size or font and font data themselves which provide the shape of the individual characters under the specification thereof. However, since there is a case in which information of the electronic document can be exploited even without the font data, the font data are deleted here in order to reduce the data amount. In this case, the security policy information may include information that specifies whether or not deletion of the font data is allowed. However, even though the security policy information does not include a statement relating whether or not deletion of the font data is allowed, the deletion of the font data is controlled, for example, so long as there is included information that specifies creation or delivery of the electronic document using the original electronic document is allowed. The font information is not deleted here, since it provides effective information relating to the characters for the amount of data. However, when no information relating to the font is necessary, the font information may be deleted together with the font data.

In one mode of the image-processing control device, the electronic processing is processing for creating or delivering the electronic document corresponding to the hard copy using the converted electronic document obtained by deleting movies or programs therefrom. In one mode of the image-processing control device, the electronic processing is processing for creating or delivering the electronic document corresponding to the hard copy using the converted electronic document obtained by converting the original electronic document into a non-colored image data (gray scaled, or binarized). The electronic document may include movies, programs, colored image data, and so on under the specification thereof. Therefore, for example, deletion of the movies or programs, or conversion of the colored image data into the non-colored image data, is performed by gray scaling or binarizing. The security policy information may include information that specifies whether or not deletion of the movies or programs or conversion into the non-colored image data is allowed.

In one mode of the image-processing control device, the electronic processing is processing for creating or delivering the electronic document corresponding to the hard copy using the converted electronic document obtained by lowering the resolution of the original electronic document. Lowering of the resolution can be achieved, for example, by performing pixel skipping or using a low-pass filter. The security policy information may include information that specifies whether or not adjustment of the resolution is allowed.

In one mode of the image-processing control device, there is provided an output controller for causing execution of the electronic processing to be stopped and making the printer or the screen output the converted electronic document, and causing the electronic processing to be started again on the basis of an instruction from the user indicating that the converted electronic document is employed. The printer or the output screen may be integrated in this processing control device or may be provided separately. By employing this configuration, whether or not the converted result is adequate can be viewed by the user in advance (preview) during use of the converted electronic document.

In one mode of the image-processing control device, there is provided a policy controller for setting security policy information for the electronic document created or delivered in the electronic processing on the basis of the security policy information on the original electronic document. For example, new security policy information can be created by copying the security policy information of the original electronic document.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An image-processing control device comprising:
a coordinate acquisition unit that acquires coordinate information with respect to an original electronic document as a printing source of a hard copy from a scanned electronic document created by scanning the hard copy;
a policy acquisition unit that acquires security policy information that specifies whether or not processing of the original electronic document on the basis of the coordinate information is allowed; and
a process controller that controls electronic processing utilizing the original electronic document to be performed on the hard copy on the basis of the acquired security policy information.

2. The image-processing control device according to claim 1, wherein the electronic processing is processing for creating a new electronic document corresponding to the hard copy using the original electronic document, and the security policy information includes information which specifies whether or not creation of the new electronic document using the original electronic document is allowed.

3. The image-processing control device according to claim 1, wherein the electronic processing is processing for delivering the electronic document corresponding to the hard copy using the original electronic document, and
wherein the security policy information includes information which specifies whether or not delivery of the electronic document using the original electronic document is allowed.

4. The image-processing control device according to claim 2, wherein the electronic processing is processing for creating the new electronic document corresponding to the hard copy using a converted electronic document obtained by deleting font data in the case where the original electronic document includes font information and the font data.

5. The image-processing control device according to claim 2, wherein the electronic processing is processing for creating the new electronic document corresponding to the hard copy using a converted electronic document obtained by deleting movies or programs from the original electronic document.

6. The image-processing control device according to claim 2, wherein the electronic processing is processing for creating the new electronic document corresponding to the hard copy using a converted electronic document obtained by converting the original electronic document into non-colored image data.

7. The image-processing control device according to claim 2, wherein the electronic processing is processing for creating the new electronic document corresponding to the hard copy using a converted electronic document obtained by lowering the resolution of the original electronic document.

8. The image-processing control device according to claim 3, wherein the electronic processing is processing for delivering the electronic document corresponding to the hard copy using a converted electronic document obtained by deleting font data in the case where the original electronic document includes font information and the font data.

9. The image-processing control device according to claim 3, wherein the electronic processing is processing for delivering the electronic document corresponding to the hard copy using a converted electronic document obtained by deleting movies or programs from the original electronic document.

10. The image-processing control device according to claim 3, wherein the electronic processing is processing for delivering the electronic document corresponding to the hard copy using a converted electronic document obtained by converting the original electronic document into non-colored image data.

11. The image-processing control device according to claim 3, wherein the electronic processing is processing for delivering the electronic document corresponding to the hard copy using a converted electronic document obtained by lowering the resolution of the original electronic document.

12. The image-processing control device according to claim 4, comprising:
an output controller for causing execution of the electronic processing to be stopped and making a printer or a screen output the converted electronic document, and causing the electronic processing to be started again on the basis of an instruction from a user indicating that the converted electronic document is employed.

13. The image-processing control device according to claim 5, comprising an output controller for causing execution of the electronic processing to be stopped and making the printer or the screen output the converted electronic document, and causing the electronic processing to be started again on the basis of an instruction from the user indicating that the converted electronic document is to be employed.

14. The image-processing control device according to claim 6, comprising an output controller for causing execution of the electronic processing to be stopped and making the printer or the screen output the converted electronic document, and causing the electronic processing to be started again on the basis of an instruction from the user indicating that the converted electronic document is to be employed.

15. The image-processing control device according to claim 7, comprising an output controller for causing execution of the electronic processing to be stopped and making the printer or the screen output the converted electronic document, and causing the electronic processing to be started again on the basis of an instruction from the user indicating that the converted electronic document is to be employed.

16. The image-processing control device according to claim 2, comprising a policy controller for setting security policy information for the new electronic document created in the electronic processing on the basis of the security policy information on the original electronic document.

17. The image-processing control device according to claim 3, comprising a policy controller for setting security policy information for the electronic document delivered in the electronic processing on the basis of the security policy information on the original electronic document.

18. The image-processing control device according to claim 4, comprising a policy controller for setting security policy information for the new electronic document created in the electronic processing on the basis of the security policy information on the original electronic document.

19. An image-processing control method comprising:
acquiring coordinate information with respect to an original electronic document as a printing source of a hard copy from a scanned electronic document created by scanning the hard copy;
acquiring security policy information that specifies whether or not processing of the original electronic document on the basis of the coordinate information is allowed; and
controlling electronic processing utilizing the original electronic document to be performed on the hard copy on the basis of the acquired security policy information.

20. A computer-readable medium storing a program causing a computer to execute a process for image-processing control, the process comprising:
acquiring coordinate information with respect to an original electronic document as a printing source of a hard copy from a scanned electronic document created by scanning the hard copy;
acquiring security policy information that specifies whether or not processing of the original electronic document on the basis of the coordinate information is allowed; and
controlling electronic processing utilizing the original electronic document to be performed on the hard copy on the basis of the acquired security policy information.
